(19) United States
(12) Patent Application Publication
(10) Pub. No.: US 2005/0207494 A1
(43) Pub. Date: Sep. 22, 2005

(54) Method and apparatus for encoding moving picture using fast motion estimation algorithm

(75) Inventors: Jong-hak Ahn, Suwon-si (KR); Sang-chang Cha, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/983,101

(22) Filed: Nov. 8, 2004

(30) Foreign Application Priority Data
Nov. 6, 2003 (KR) 10-2003-0078428

(51) Int. Cl. H04N 7/12

(52) U.S. Cl. 375/240.16; 375/240.24; 375/240.12

(57) ABSTRACT

A method and apparatus for encoding a moving picture using a fast motion estimation algorithm are provided. The method includes motion estimation performed by obtaining motion vectors of representative sub-blocks of macroblocks each containing a plurality of sub-blocks, respectively, and by estimating motion vectors of all sub-blocks other than the representative sub-blocks using relationships among the motion vectors of the representative sub-blocks. In the method and apparatus, motion estimation requiring a large amount of computation in encoding a moving picture can be performed quickly and accurately.

### BACKGROUND OF THE INVENTION

This application claims the priority of Korean Patent Application No. 10-2003-0078428 filed on Nov. 6, 2003 in the Korean Intellectual Property Office, the disclosure of which is incorporated herein in its entirety by reference.

1. Field of the Invention

The present invention relates to a method and apparatus for estimating a motion in compressing a moving picture.

2. Description of the Related Art

With the development of information communication technology including the Internet, video communication as well as text and voice communication has rapidly increased. Conventional text communication cannot satisfy the various demands of users, and thus multimedia services that can provide various types of information such as text, pictures, and music have increased. Multimedia data requires a large capacity storage medium and a wide bandwidth for transmission, since the amount of multimedia data is usually large. For example, a 24-bit true color image having a resolution of 640×480 needs a capacity of 640×480×24 bits, i.e., data of about 7.37 Mbits, per frame. When this image is transmitted at a speed of 30 frames per second, a bandwidth of 221 Mbits/sec is required. When a 90-minute movie based on such an image is stored, a storage space of about 1200 Gbits is required. Accordingly, a compression coding method is a requisite for transmitting multimedia data including text, video, and audio.

A basic principle of data compression is removing data redundancy. Data can be compressed by removing spatial redundancy in which the same color or object is repeated in an image, temporal redundancy in which there is little change between adjacent frames in a moving image or the same sound is repeated in audio, or mental visual redundancy taking into account human eyesight and limited perception of high frequency. Data compression can be classified into lossy/lossless compression according to whether source data is lost, intraframe/interframe compression according to whether individual frames are compressed independently, and symmetric/asymmetric compression according to whether time required for compression is the same as time required for recovery. Data compression is defined as real-time compression when a compression/recovery time delay does not exceed 50 ms and as scalable compression when frames have different resolutions. For text or medical data, lossless compression is usually used. For multimedia data, lossy compression is usually used. Meanwhile, intraframe compression is usually used to remove spatial redundancy, and interframe compression is usually used to remove temporal redundancy.

Different types of transmission media for multimedia have different performance. Currently used transmission media have various transmission rates. For example, an ultrahigh-speed communication network can transmit data of several tens of megabits per second while a mobile communication network has a transmission rate of 384 kilobits per second. In conventional video coding methods such as Motion Picture Experts Group (MPEG)-1, MPEG-2, H.263, and H.264, temporal redundancy is removed by motion compensation based on motion estimation and compensation, and spatial redundancy is removed by transform coding.

Removing temporal redundancy will now be described in more detail. In removing temporal redundancy, motion estimation is performed to obtain a motion vector indicating a degree of movement of each of the units, e.g., macroblocks, constituting a frame between two adjacent frames. After the motion estimation, motion compensation is performed to remove temporal redundancy between the frames through temporal filtering.

Such a process for removing the temporal redundancy requires a large amount of computation. To reduce the amount of computation, various algorithms have been introduced. Representatively, there are approaches for reducing the number of candidates for a motion vector, for reducing the amount of computation of a block matching cost function, and for sub-sampling a motion vector.

In the algorithm for sub-sampling a motion vector, a macroblock is divided into sub-blocks, and a motion vector of a sub-block is used as a motion vector of the macroblock.

FIGS. 1A, 1B, and 1C illustrate approaches for reducing the number of candidates for a motion vector. FIG. 1A illustrates a three step search. In the three step search, mean absolute differences (MADs) are calculated with respect to 9 points including a center, and a point (i.e., white point 1) having a minimum MAD is searched out. Next, MADs are calculated with respect to 9 points including the searched-out point, whose intervals are one-step less than intervals among the previous 9 points, and a point (i.e., white point 2) having a minimum MAD is searched out. Finally, MADs are calculated again with respect to 9 points defined referring to the secondly searched-out point, in the same manner as described above, and a point (i.e., white point 3) having a minimum MAD is searched out. According to the three step search, a motion vector can be determined through only three steps, and a search range is reduced step-by-step.

FIG. 1B illustrates a 2D (dimensional) logarithm search, which is similar to the three step search but is capable of searching out a more accurate motion vector since the 2D logarithm search uses more candidates in a narrow-range search than the three step search.

FIG. 1C illustrates an adaptive/predictive search in which a motion vector of a current block is predicted using motion vectors of adjacent blocks between a current frame and a previous frame and search is performed centering around a candidate corresponding to the predicted motion vector. In particular, where motion vectors of A, B, and C blocks are known, an average of the motion vectors of the A, B, and C blocks is predicted as a motion vector of a block whose motion vector is not known, and a motion vector is searched centering around a candidate positioned in correspondence with the predicted motion vector.

In an approach for reducing the amount of computation of a block matching cost function, a widely spread sum of absolute differences (SAD) is defined as Equation (1), and a motion vector of a block is defined as Equation (2):

$$SAD ( dx , dy ) = {\sum }_{m = x}^{x + N - 1} {\sum }_{n = y}^{y + N - 1} \vert {I}_{k} ( m , n ) - {I}_{k - 1} ( m + dx , n + dy ) \vert \qquad ( 1 )$$

where N denotes a size of a macroblock, and Iₖ(m,n) denotes an intensity of a pixel (m,n) in a k-th frame; and
   \overline{MV}=(MVₓ,MV_{y})=(dx,dy)∈R²|min SAD(dx,dy) (2)
   where R² denotes a search range. In other words, a motion vector is (dx,dy) giving a minimum SAD in the search range. However, this approach needs N*N subtractions and N*(N−1) additions per one candidate. To reduce the amount of computation of the SAD, another cost function or a transformed SAD may be used. For example, in a method referred to as a decimated MAD, a SAD is obtained using decimated ¼ pixels among N*N pixels. In a method referred to as matched pixel counting, a SAD is not obtained, but a motion vector is determined using the number of identical pixels.

The above-described conventional methods have a characteristic that a local minimum is likely selected as a motion vector. Where a minimum candidate is selected from among candidates, an optimal motion vector cannot be selected if a point other than the candidates is less than the minimum candidate. If the number of candidates is increased to overcome this problem, the amount of computation is usually increased. In other words, a certain trade-off exists between the amount of computation and the accuracy of motion vector estimation.

Motion estimation is like a bottleneck in compression of a moving picture. For example, in a case where an encoder having a 15×15 pixel search range uses a full search algorithm in an MPEG-1 system, motion estimation occupies 75% of the total computational amount of an encoding system, which does not allow a real-time operation.

Motion estimation is essential to the performance of moving picture compression but requires a large amount of computation. Accordingly, an algorithm for fast motion estimation is desired to realize real-time moving picture encoding. In particular, an algorithm for fast motion estimation is desired much more where a variable block size motion compensation is performed as in the H.264 standard since motion estimation needs to be performed for each block size, and this increases the amount of computation.

### SUMMARY OF THE INVENTION

The present invention provides a method and apparatus for estimating a motion quickly during encoding of a moving picture.

According to an exemplary embodiment of the present invention, there is a method of encoding a moving picture, the method including motion estimation performed by obtaining motion vectors of representative sub-blocks of macroblocks, respectively, each macroblock including a plurality of sub-blocks and by estimating motion vectors of all sub-blocks other than the representative sub-blocks using relationships among the motion vectors of the representative sub-blocks. The motion estimation may comprise (a) obtaining the motion vectors of the representative sub-blocks of the macroblocks each containing a plurality of sub-blocks, respectively, and (b) estimating motion vectors of all sub-blocks using the relationships among the motion vectors of the representative sub-blocks. Step (a) may comprise searching a predetermined search range defined based on a motion vector predicted from motion vectors of representative sub-blocks of respective macroblocks adjacent to a current macroblock, thereby obtaining a motion vector of the current macroblock. Each macroblock has a size of 16×16 pixels, each of the sub-blocks contained in each macroblock has a size of 4×4 pixels, and a representative sub-block of each macroblock is one sub-block among sub-blocks located at a center of the macroblock.

When a difference between a motion vector of a representative sub-block of a current macroblock and each of motion vectors of representative sub-blocks of adjacent macroblocks is less than a first reference value “a”, step (b) comprises determining motion vectors of respective sub-blocks contained in the current macroblock as the motion vector of the representative sub-block of the current macroblock. In an exemplary embodiment, the adjacent macroblocks are located above, below, on the left of, and on the right of the current macroblock.

When a difference between a motion vector of a representative sub-block of a current macroblock and a motion vector of at least one representative sub-block among representative sub-blocks of adjacent macroblocks is equal to or greater than a first reference value “a”, step (b) may comprise (b1) dividing the current macroblock into four upper left, upper right, lower-left, and lower-right blocks and obtaining upper left, upper right, lower-left, and lower-right motion vectors of representative sub-blocks of the divided four blocks, and (b2) obtaining motion vectors of other sub-blocks of the divided four blocks using a difference Diff(u) between the upper left motion vector and the upper right motion vector, a difference Diff(d) between the lower-left motion vector and the lower-right motion vector, a difference Diff(l) between the upper left motion vector and the lower-left motion vector, and a difference Diff(r) between the upper right motion vector and the lower-right motion vector.

Step (b1) may comprise performing a search in a range determined using the motion vectors of the representative sub-blocks of the adjacent macroblocks to obtain the upper left, upper right, lower-left, and lower-right motion vectors.

When all of the differences Diff(u), Diff(d), Diff(l), and Diff(r) are less than a second reference value “b”, step (b2) may comprise determining motion vectors of the sub-blocks contained in the current macroblock as an average of the upper left, upper right, lower-left, and lower-right motion vectors. When both of the differences Diff(u) and Diff(d) are less than a second reference value “b” and when at least one of the differences Diff(l) and Diff(r) is the second predetermined value “b”, step (b2) may comprise determining motion vectors of sub-blocks contained in the upper left and upper right blocks as an average of the upper left motion vector and the upper right motion vector and determining motion vectors of sub-blocks contained in the lower-left and lower-right blocks as an average of the lower-left motion vector and the lower-right motion vector. When both of the differences Diff(l) and Diff(r) are less than a second reference value “b” and when at least one of the differences Diff(u) and Diff(d) is equal to or greater than the second predetermined value “b”, step (b2) may comprise determining motion vectors of sub-blocks contained in the upper left and lower-left blocks as an average of the upper left motion vector and the lower-left motion vector and determining motion vectors of sub-blocks contained in the upper right and lower-right blocks as an average of the upper right motion vector and the lower-right motion vector. In this case, the motion estimation is performed based on a variable block having a variable size and a variable shape, and the size and the shape of the variable block are determined in such a range that sub-blocks' motion vectors obtained using the motion vectors of the representative sub-blocks are the same.

According to another exemplary embodiment of the present invention, there is provided a method of encoding a moving picture, the method including determining a size and a shape of a unit block, on which motion estimation is performed, by using a relationship among motion vectors of representative sub-blocks of macroblocks, each macroblock including a plurality of sub-blocks.

Determining the size and the shape of the unit block may comprises (a) obtaining the motion vectors of the representative sub-blocks of the macroblocks each containing a plurality of sub-blocks, respectively, and (b) determining the size and the shape of the unit block, on which motion estimation is performed, according to the relationship among the motion vectors of the representative sub-blocks.

Step (a) may comprise searching a predetermined search range defined based on a motion vector predicted from motion vectors of representative sub-blocks of respective macroblocks adjacent to a current macroblock, thereby obtaining a motion vector of the current macroblock. In an exemplary embodiment, each macroblock has a size of 16×16 pixels, each of the sub-blocks contained in each macroblock has a size of 4×4 pixels, and a representative sub-block of each macroblock is one sub-block among sub-blocks located at a center of the macroblock.

When a difference between a motion vector of a representative sub-block of a current macroblock and each of motion vectors of representative sub-blocks of adjacent macroblocks is less than a first reference value “a”, step (b) may comprise determining motion vectors of respective sub-blocks contained in the current macroblock as the motion vector of the representative sub-block of the current macroblock. Here, the adjacent macroblocks are located above, below, on the left of, and on the right of the current macroblock.

When a difference between a motion vector of a representative sub-block of a current macroblock and a motion vector of at least one representative sub-block among representative sub-blocks of adjacent macroblocks is equal to or greater than a first reference value “a”, step (b) may comprise (b1) dividing the current macroblock into four upper left, upper right, lower-left, and lower-right blocks and obtaining upper left, upper right, lower-left, and lower-right motion vectors of representative sub-blocks of the divided four blocks, and (b2) determining the size and the shape of the unit block for motion estimation using a difference Diff(u) between the upper left motion vector and the upper right motion vector, a difference Diff(d) between the lower-left motion vector and the lower-right motion vector, a difference Diff(l) between the upper left motion vector and the lower-left motion vector, and a difference Diff(r) between the upper right motion vector and the lower-right motion vector.

In an exemplary embodiment, step (b1) comprises performing a search in a range determined using the motion vectors of the representative sub-blocks of the adjacent macroblocks to obtain the upper left, upper right, lower-left, and lower-right motion vectors.

When all of the differences Diff(u), Diff(d), Diff(l), and Diff(r) are less than a second reference value “b”, step (b2) may comprise determining the size and the shape of the unit block for motion estimation as a size and a shape of a macroblock. When both of the differences Diff(u) and Diff(d) are less than a second reference value “b” and when at least one of the differences Diff(l) and Diff(r) is equal to or greater than the second predetermined value “b”, step (b2) may comprise determining the size and the shape of the unit block for motion estimation as a size and a shape of either of a block obtained by adding the upper left block and the upper right block and a block obtained by adding the lower-left block and the lower-right block. When both of the differences Diff(l) and Diff(r) are less than a second reference value “b” and when at least one of the differences Diff(u) and Diff(d) is equal to or greater than the second predetermined value “b”, step (b2) may comprise determining the size and the shape of the unit block for motion estimation as a size and a shape of either of a block obtained by adding the upper left block and the lower-left block and a block obtained by adding the upper right block and the lower-right block.

When at least one of the differences Diff(l) and Diff(r) is equal to or greater than a second reference value “b” and when at least one of the differences Diff(u) and Diff(d) is equal to or greater than the second predetermined value “b”, step (b2) may comprise (b21) dividing each of the four blocks into four upper left, upper right, lower-left, and lower-right sub-blocks and obtaining first, second, third, and fourth motion vectors of the respective four sub-blocks of each block, and (b22) determining the size and the shape of the unit block for motion estimation using a difference Diff(uu) between the first motion vector and the second motion vector, a difference Diff(dd) between the third motion vector and the fourth motion vector, a difference Diff(ll) between the first motion vector and the third motion vector, and a difference Diff(rr) between the second motion vector and the fourth motion vector. Step (b2) may comprise determining the size and the shape of the unit block for motion estimation as a size and a shape of any one of the four blocks when all of the differences Diff(uu), Diff(dd), Diff(ll), and Diff(rr) are less than a third reference value “c”, as a size and a shape of either of a block obtained by adding the upper left sub-block and the upper right sub-block and a block obtained by adding the lower-left sub-block and the lower-right sub-block when both of the differences Diff(uu) and Diff(dd) are less than the third reference value “c” and at least one of the differences Diff(ll) and Diff(rr) is equal to or greater than the third predetermined value “c”, and as a size and a shape of either of a block obtained by adding the upper left sub-block and the lower-left sub-block and a block obtained by adding the upper-right sub-block and the lower-right sub-block when both of the differences Diff(ll) and Diff(rr) are less than the third reference value “c” and at least one of the differences Diff(uu) and Diff(dd) is equal to or greater than the third predetermined value “c”.

According to still another exemplary embodiment of the present invention, there is provided an apparatus for encoding a moving picture, the apparatus including a motion estimation unit which estimates a motion of an input image using the input image and a reference frame so that the estimated motion is used for motion compensation temporal filtering. The motion estimation unit obtains motion vectors of representative sub-blocks of macroblocks, respectively, each macroblock including a plurality of sub-blocks, and estimates a motion of the input image using relationships among the motion vectors of the representative sub-blocks.

The motion estimation unit may comprise a sub-block motion estimator which obtains the motion vectors of the representative sub-blocks, a mode determiner which selects a unit block for the motion estimation using the relationships among the motion vectors obtained by the sub-block motion estimator, and a search range determination and motion vector prediction part which transmits a search range and a prediction value for a motion vector of each of predetermined sub-blocks to the sub-block motion estimator when a mode is not determined by the mode determiner.

The search range determination and motion vector prediction part obtains the prediction value for the motion vector using adjacent motion vectors. The search range for the motion vector is determined as a range of motion vectors of representative sub-blocks of macroblocks respectively located above, below, on the left of, and on the right of a macroblock to which a predetermined sub-block belongs.

### BRIEF DESCRIPTION OF THE DRAWINGS

The above and other features and advantages of the present invention will become more apparent by describing in detail exemplary embodiments thereof with reference to the attached drawings in which:

FIGS. 1A, 1B, and 1C illustrate conventional motion estimation algorithms;

FIG. 2 is a functional block diagram of an H.264 encoder;

FIG. 3 is a functional block diagram of a motion estimation unit according to an embodiment of the present invention;

FIG. 4A illustrates variable block sizes in a hierarchical structure of an H.264 standard;

FIG. 4B illustrates an example of a result of performing variable block size motion compensation according to the H.264 standard;

FIGS. 5A through 5C illustrate mode determination and motion estimation according to an embodiment of the present invention; and

FIG. 6 is a flowchart of a method for mode determination and motion estimation according to an embodiment of the present invention.

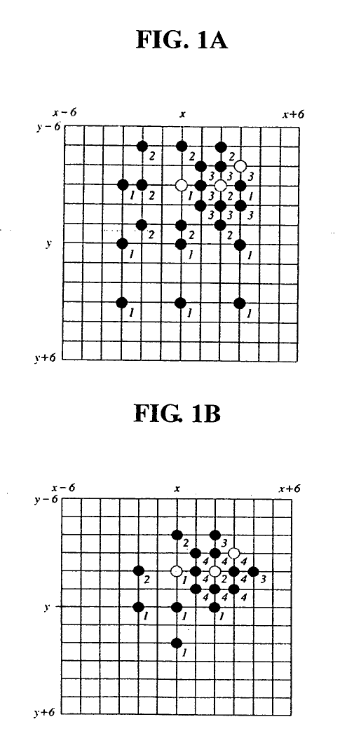

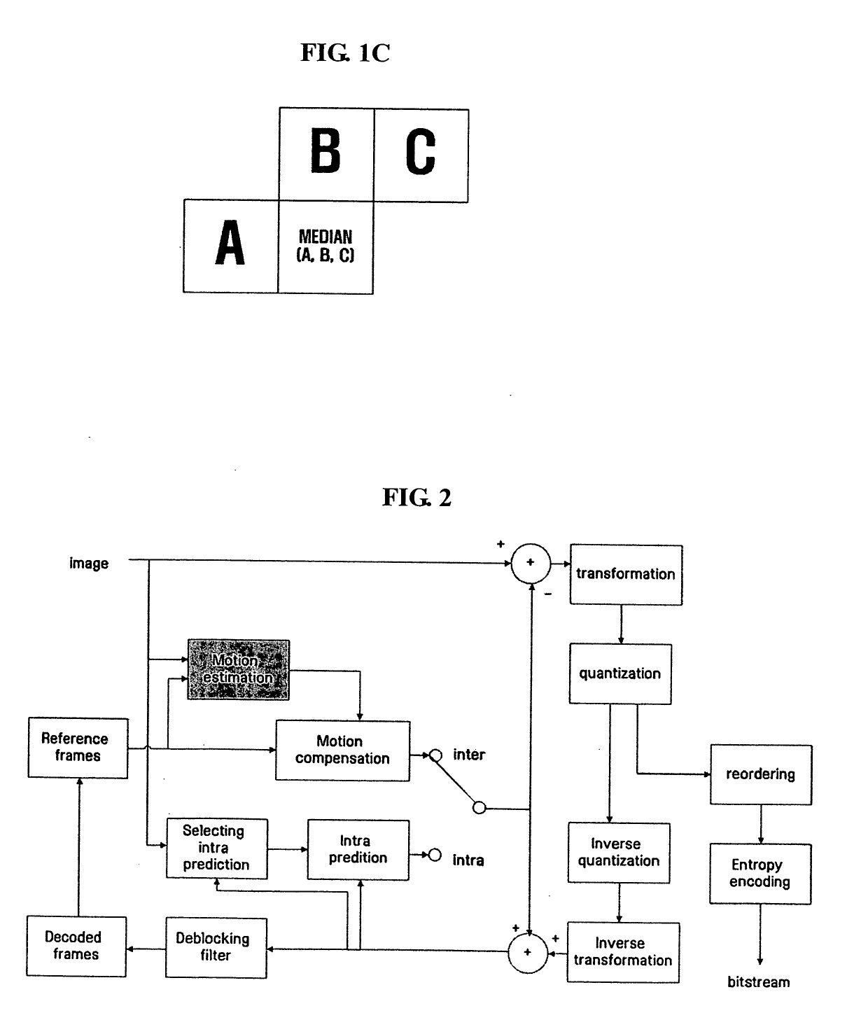

### DETAILED DESCRIPTION OF THE INVENTION

Exemplary embodiments of the present invention will now be described with reference to the accompanying drawings.

FIG. 2 is a functional block diagram of an H.264 encoder.

In coding a moving picture, a moving picture image can be divided into an intra-frame which is compressed independently of other frames and an inter-frame which is compressed based on other frames. In moving picture experts group (MPEG) compression, an I-frame corresponds to the intra-frame, and a P-frame that is compressed based on an I-frame or another P-frame and a B-frame that interpolates two different frames correspond to inter-frames.

An input image is sequentially subjected to temporal redundancy removal, spatial redundancy removal, quantization, reordering, and entropy coding and is then output in the form of a bitstream. To remove temporal redundancy, a motion is estimated and compensated for, and then temporal filtering is performed. For intra pictures, motion compensation is omitted. Spatial redundancy is removed through transform. MPEG standards use a discrete cosine transform (DCT) and an H.264 standard uses an integer transform in order to remove the spatial redundancy. Although the quantization decreases an entire accuracy of integer coefficients, it is used to remove high-frequency coefficients. The H.264 standard uses context-based adaptive binary arithmetic coding (CABAC) for entropy coding and an adaptive probability mode1 for most symbols.

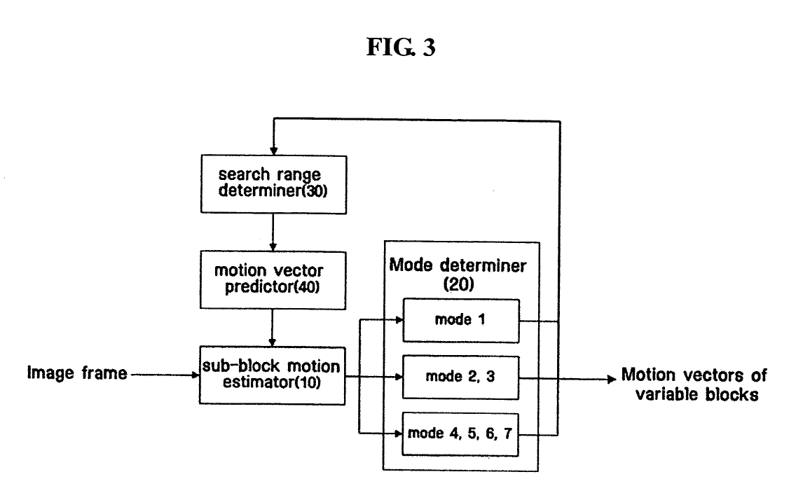

In most algorithms for moving picture compression, motion estimation and compensation is required for removing temporal redundancy. Since motion estimation requires a large amount of computation, a micro processor having high operating performance is required to compress moving pictures in real time, which incurs an increase in the price of a moving picture coding apparatus. The present invention provides a more efficient algorithm for motion estimation and a moving picture compression method and apparatus using the algorithm. An apparatus for motion estimation will be described in detail with reference to FIG. 3.

FIG. 3 is a functional block diagram of a motion estimation unit according to an embodiment of the present invention.

A sub-block motion estimator 10 obtains motion vectors of some sub-blocks of an input image frame. Where motion vectors of adjacent sub-blocks are known, one may determine a search range for a motion vector with reference to the known motion vectors of the adjacent sub-blocks. In an embodiment of the present invention, the sub-block motion estimator 10 obtains a motion vector of a representative sub-block having a size of 4×4 pixels at a center of a macroblock having a size of 16×16 pixels.

A mode determiner 20 determines a mode based on a relationship among motion vectors of representative sub-blocks. If motion vectors of a given number of sub-blocks are not sufficient to determine a mode, the mode determiner 20 uses motion vectors of more sub-blocks than the given number of sub-blocks to determine a mode.

A search range determiner 30 determines a search range for a motion vector of each sub-block when a mode cannot be determined, so that motion vectors of more sub-blocks than the given number of sub-blocks can be obtained.

A motion vector predictor 40 predicts a motion vector from a motion vector of a given sub-block so that a motion vector of sub-blocks can be obtained. The sub-block motion estimator 10 estimates a motion vector of a current sub-block based on the predicted motion vector and the search range. After estimating the motion vector, a mode is determined again. If the mode cannot be determined, the above operations are reflexively repeated.

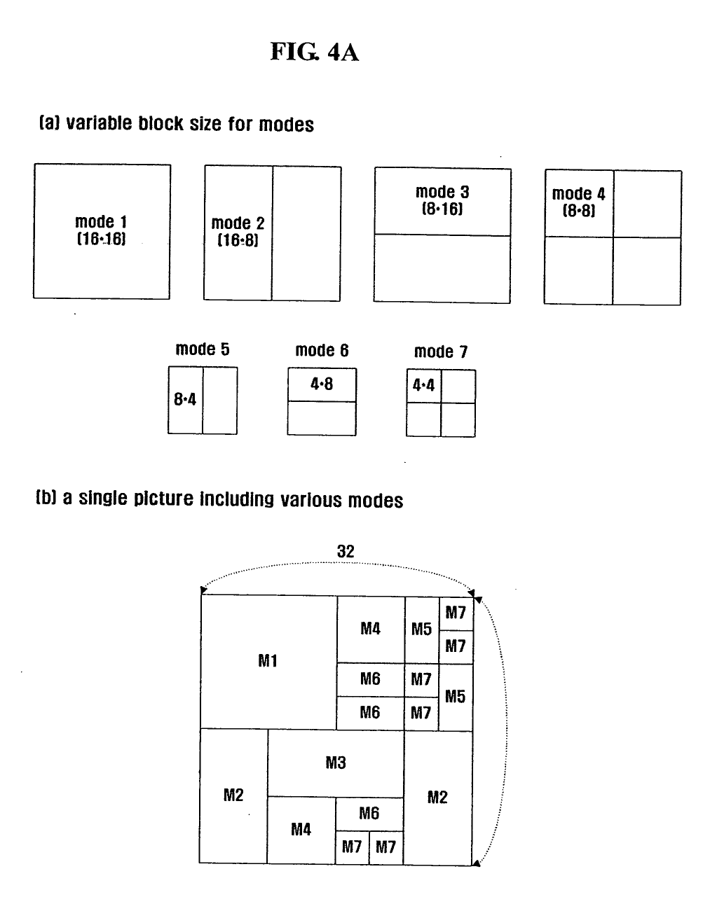

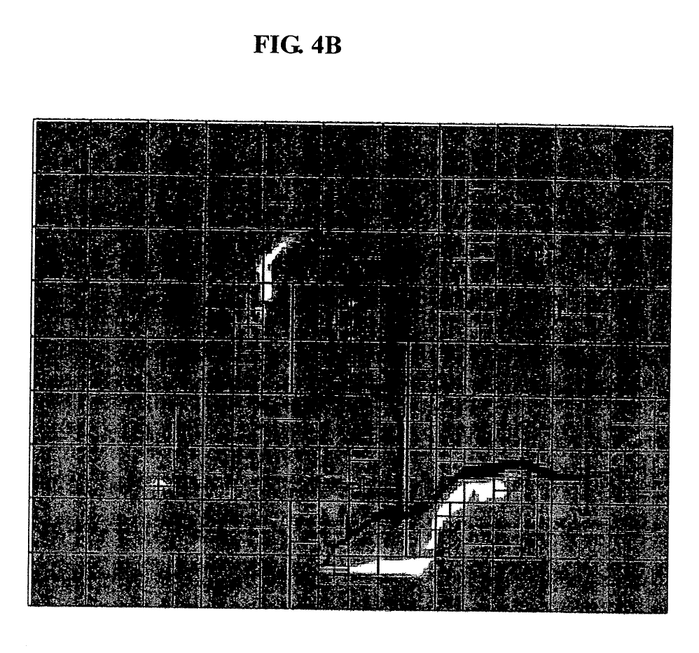

FIG. 4A illustrates variable block sizes in a hierarchical structure of the H.264 standard.

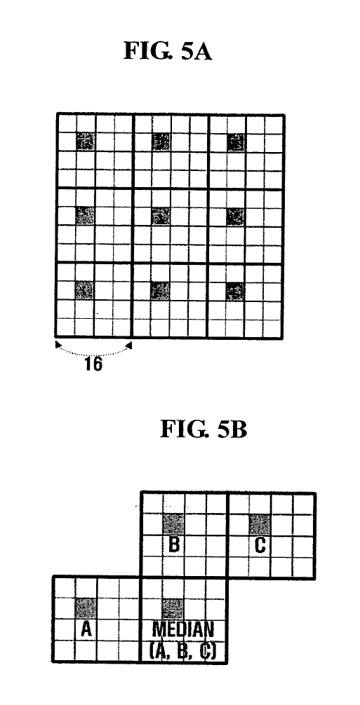

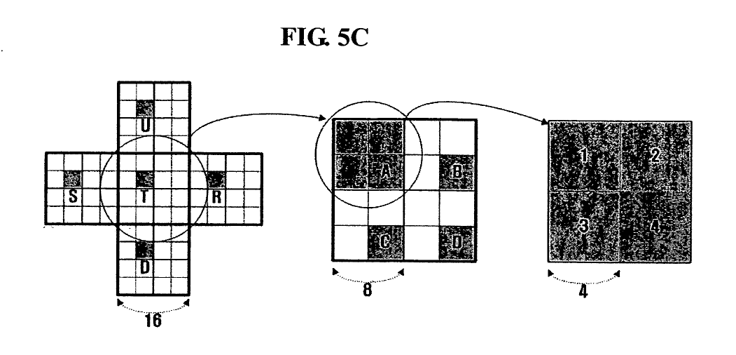

In the H.264 standard, a tree-structure variable block size motion compensation is performed, as shown in FIG. 4A. In motion estimation, sums of absolute differences (SADs) are obtained in 7 modes, and a motion vector is obtained in a mode having a minimum SAD. For a macroblock having a size of 16×16 pixels, mode1 (M1) through mode3 (M3) can be selected. For a block having a size of 8×8 pixels, mode4 (M4) through mode6 (M6) can be selected. For a sub-block having a size of 4×4 pixels, a mode7 (M7) can be selected. As shown in FIG. 4A, a single picture includes various modes. FIG. 4B illustrates an example of a result of performing variable block size motion compensation according to the H.264 standard. Referring to FIG. 4B, M1 is selected for a background having almost no motions, while a higher mode is selected for a portion having many motions. Bright portions indicate that there is a big difference between two frames. For motion estimation according to the H.264 standard, SADs are obtained with respect to all of sub-blocks having a size of 4×4 pixels, SADs for adjacent sub-blocks are added to obtain SADs for sub-blocks respectively having sizes of 4×8 pixels, 8×4 pixels, 8×8 pixels, 16×8 pixels, 8×16 pixels, and 16×16 pixels, and the obtained SADs for the different sized sub-blocks are compared with one another. This method requires a huge amount of computation, thereby increasing time and cost for moving picture coding. The exemplary embodiments of the present invention provide a more efficient algorithm for variable block size motion estimation, which will be described with reference to FIGS. 5A through 5C.

FIGS. 5A through 5C illustrate mode determination and motion estimation according to an embodiment of the present invention.

In FIGS. 5A through 5C, a bold outlined square denotes a macroblock having a size of 16×16 pixels, and a shaded small square having a size of 4×4 pixels denotes a representative sub-block representing a macroblock. As shown in FIG. 5A, a motion vector of a representative sub-block of each macroblock is calculated. In an exemplary embodiment, a representative sub-block is one among four sub-blocks at a center of a macroblock. However, the spirit of the present invention is not restricted thereto. When a motion vector of a representative sub-block is obtained, the amount of computation can be reduced by using representative sub-blocks' motion vectors that have been obtained, as shown in FIG. 5B. Referring to FIG. 5B, where motion vectors of A, B, and C sub-blocks in macroblocks adjacent to a current macroblock have been obtained, an average of the motion vectors MEDIAN(A,B,C) is predicted as a motion vector of a representative sub-block in the current macroblock, and the motion vector of the representative sub-block is obtained using the predicted motion vector.

Referring to FIG. 5C, where motion vectors of representative sub-blocks in all of macroblocks have been obtained, a motion vector of a representative sub-block in a current macroblock is compared with motion vectors of representative sub-blocks in adjacent macroblocks. The adjacent macroblocks may be 8 macroblocks surrounding the current macroblock, but also the adjacent macroblocks may be upper, lower, left, and right macroblocks respectively including representative sub-blocks U, D, L, and R. Mode1 is determined if Formula (1) is satisfied:
|MV(T)−MV(X)|<a (1)
where MV(T) indicates a motion vector of a sub-block T, X indicates the representative sub-blocks U, D, L, and R, and “a” indicates a size of one (1) pixel as a predetermined reference value.

If Formula (1) is satisfied, it may be determined that a motion difference among sub-blocks contained in a macroblock including the sub-block T is very small, and thus mode1 is determined. In other words, a motion vector of the macroblock including the sub-block T may be determined as MV(C). Where a motion is estimated in units of sub-blocks having a size of 4×4 pixels, motion vectors of all sub-blocks contained in the macroblock including the sub-block T may be determined as MV(C).

If Formula (1) is not satisfied, the macroblock is divided into four blocks having a size of 8×8 pixels, and a motion vector of a representative sub-block in each of the four blocks is calculated. A search range can be defined for the motion vector. In an exemplary embodiment, the search range is determined using Formula (2):
MV(L)_x<MV(Y)_x<MV(R)
MV(D)_y<MV(Y)_y<MV(U) (2)
where MV(Y)_x and MV(Y)_y respectively indicate an x-component and a y-component of a motion vector of a Y sub-block, Y corresponds to a B, C, or D value, and MV(L)_x<MV(Y)_x<MV(R) indicates a value between MV(L)_x and MV(R)_x.

“A” denotes a sub-block corresponding to T in Formula (1). A motion vector of the sub-block A is already known and thus is used to calculate motion vectors of sub-blocks B, C, and D. In particular, a predicted vector for the motion vectors of the sub-blocks B, C, and D is set as MV(T=A) and a search range is determined using Formula (2) in order to obtain the motion vectors of the sub-blocks B, C, and D.

After obtaining the motion vectors of all of the sub-blocks A, B, C, and D, relationships among the motion vectors are defined by differences among the motion vectors for mode and motion estimation. The relationships among the motion vectors are defined in Formula (3):
Diff(u)=|MV(A)−MV(B)|
Diff(d)=|MV(C)−MV(D)
Diff(l)=|MV(A)−MV(C)|
Diff(r)=|MV(B)−MV(D)| (3)
where, if all of Diff(u), Diff(d), Diff(l), and Diff(r) are less than a predetermined value “b”, it may be determined that there is almost no difference in motion among the four 8×8 pixel blocks. Accordingly, in this case, mode1 is determined. Here, a motion vector of the macroblock may be determined as MV(A) but also may be determined as an average of MV(A), MV(B), MV(C), and MV(D). Meanwhile, if motion estimation is performed in units of 4×4 pixel sub-blocks, motion vectors of all sub-blocks constituting the macroblock may be determined as an average of MV(A), MV(B), MV(C), and MV(D). Alternatively, motion vectors of sub-blocks in a block including the sub-block A may be determined as MV(A); motion vectors of sub-blocks in a block including the sub-block B may be determined as MV(B); motion vectors of sub-blocks in a block including the sub-block C may be determined as MV(C); and motion vectors of sub-blocks in a block including the sub-block D may be determined as MV(D). Here, the predetermined value “b” is a half (½) pixel size.

If mode1 is not available, that is, if at least one among Diff(u), Diff(d), Diff(l), and Diff(r) is equal to or greater than the predetermined value “b”, it is determined whether mode2 or mode3 is available. Mode2 is selected when Formula (4) is satisfied while mode3 is selected when Formula (5) is satisfied:
Diff(l)<b and Diff(r)<b (4)
Diff(u)<b and Diff(d)<b (5)
wherein when Formula (4) is satisfied, it may be determined that motions are almost similar among sub-blocks in a vertical direction, and thus mode2 is selected. In this case, motion estimation of an 8×4 pixel block including the sub-blocks A and B may be made at an average of MV(A) and MV(B); and motion estimation of an 8×4 pixel block including the sub-blocks B and D may be made at an average of MV(B) and MV(D). When motion estimation is performed in units of 4×4 pixel sub-blocks, motion estimation of all sub-blocks in the 8×4 pixel block including the sub-blocks A and B may be made at the average of MV(A) and MV(B); and motion estimation of all sub-blocks in the 8×4 pixel block including the sub-blocks B and D may be made at the average of MV(B) and MV(D).

If both of mode2 and mode3 are not available, an 8×8 pixel block is divided into 4×4 pixel blocks, and motion vectors of the respective 4×4 pixel blocks are obtained. In FIG. 5C, a block including the sub-block A is divided into sub-blocks 1, 2, 3, and 4. Here, a motion vector of the sub-block A (=4) predicted motion vector, and motion vectors of the respective sub-blocks 1, 2, and 3 are obtained using the predicted motion vector. In an exemplary embodiment, a search range is determined by Formula (2). After the motion vectors of all of the sub-blocks 1, 2, 3, and 4 are obtained, relationships among the motion vectors are defined by differences among the motion vectors to determine a mode. The relationships among the motion vectors are defined as Formula (6):
Diff(uu)=|MV(1)−MV(2)|
Diff(dd)=|MV(3)−MV(4)|
Diff(ll)=|MV(1)−MV(3)|
Diff(rr)=|MV(2)−MV(4)| (6)
where, if all of Diff(uu), Diff(dd), Diff(ll), and Diff(rr) are less than a predetermined value “c”, it may be determined that there is almost no difference in motion among the four 4×4 pixel blocks. Accordingly, in this case, mode4 is determined. A motion vector of the 8×8 pixel block may be determined as an average of MV(1), MV(2), MV(3), and MV(4). In an exemplary embodiment, the predetermined value “c” is a ¼ pixel size. If mode4 is not available, mode5 may be determined when Diff(ll) and Diff(rr) are less than the predetermined value “c” while mode6 may be determined when Diff(uu) and Diff(dd) are less than the predetermined value “c”. In other cases, mode7 is determined.

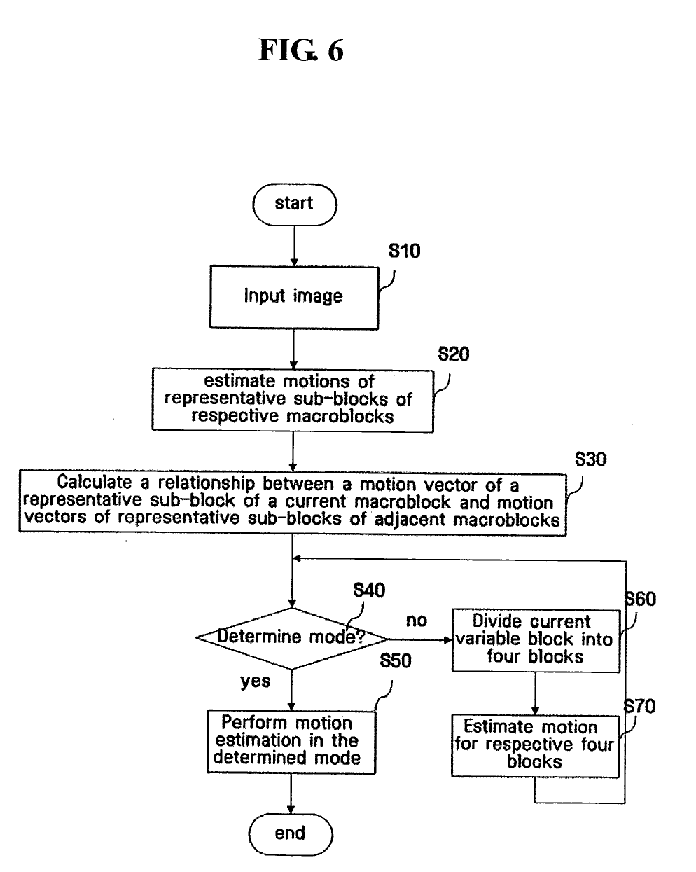

FIG. 6 is a flowchart of a method for mode determination and motion estimation according to an embodiment of the present invention.

An image is input in step S10. The input image is compared with a reference image to estimate motions of representative sub-blocks of macroblocks in step S20. In an exemplary embodiment, already known motion vectors are used. After obtaining motion vectors of all representative sub-blocks, a relationship between a motion vector of a representative sub-block of a current macroblock and motion vectors of representative sub-blocks of adjacent macroblocks is calculated in step S30. It is determined whether a mode can be determined using a predetermined calculation in step S40. If a mode is determined, motion estimation is performed in the determined mode and a motion vector of a current variable block is determined in step S50. If a mode cannot be determined, the current variable block is divided into four blocks in step S60. Representative sub-blocks of the respective four blocks are determined, and motion vectors of the respective representative sub-blocks are obtained in step S70. Thereafter, it is determined whether a mode can be determined using the predetermined calculation in step S40. If a mode is determined, motion estimation is performed in the determined mode and a motion vector of the current variable block is determined in step S50. If a mode cannot be determined, steps S60 and S70 are repeated.

It will be apparent to one skilled in the art that the invention may be embodied in other specific forms without departing from its spirit or essential characteristics. For example, while the embodiments of the present invention have been described based on H.264, it will be construed that determining a mode of a variable block using motion vectors of some sub-blocks and obtaining motion vectors of other sub-blocks or a motion vector of the variable block using the motion vectors of the some sub-blocks are included in the spirit and the scope of the present invention. Therefore, the described embodiments are to be considered in all respects only as illustrative and not restrictive and the scope of the invention is indicated by the appended claims rather than the foregoing description. All changes which come within the meaning and range of equivalency of the claims are to be embraced within their scope.

According to the present invention, in encoding moving pictures, motion estimation requiring a large amount of computation can be performed quickly and accurately so that moving pictures are compressed at low cost with a reduced time.

1. A method of encoding a moving picture using motion compensation prediction, the method comprising performing motion estimation, wherein the motion estimation comprises:
(a) obtaining motion vectors of representative sub-blocks of macroblocks each containing a plurality of sub-blocks, respectively, and
(b) estimating motion vectors of all sub-blocks other than the representative sub-blocks using relationships among the motion vectors of the representative sub-blocks.

2. The method of claim 1, wherein step (a) comprises searching a predetermined search range defined based on a motion vector predicted from motion vectors of representative sub-blocks of respective macroblocks adjacent to a current macroblock, thereby obtaining a motion vector of the current macroblock.

3. The method of claim 1, wherein each macroblock has a size of 16×16 pixels; each of the sub-blocks contained in each macroblock has a size of 4×4 pixels; and a representative sub-block of each macroblock is one sub-block among sub-blocks located at a center of the macroblock.

4. The method of claim 1, wherein when a difference between a motion vector of a representative sub-block of a current macroblock and each of motion vectors of representative sub-blocks of adjacent macroblocks is less than a first reference value, step (b) comprises determining motion vectors of respective sub-blocks contained in the current macroblock as the motion vector of the representative sub-block of the current macroblock.

5. The method of claim 4, wherein the adjacent macroblocks are located above, below, on the left of, and on the right of the current macroblock.

6. The method of claim 4, wherein the first reference value comprises a one pixel size.

7. The method of claim 5, wherein the first reference value comprises a one pixel size.

8. The method of claim 1, wherein when a difference between a motion vector of a representative sub-block of a current macroblock and a motion vector of at least one representative sub-block among representative sub-blocks of adjacent macroblocks is equal to or greater than a first reference value, step (b) comprises:
(b1) dividing the current macroblock into four blocks comprising upper left, upper right, lower-left, and lower-right blocks and obtaining upper left, upper right, lower-left, and lower-right motion vectors of representative sub-blocks of the divided four blocks; and
(b2) obtaining motion vectors of other sub-blocks of the divided four blocks using a difference Diff(u) between the upper left motion vector and the upper right motion vector, a difference Diff(d) between the lower-left motion vector and the lower-right motion vector, a difference Diff(l) between the upper left motion vector and the lower-left motion vector, and a difference Diff(r) between the upper right motion vector and the lower-right motion vector.

9. The method of claim 8, wherein step (b1) comprises performing a search in a range determined using the motion vectors of the representative sub-blocks of the adjacent macroblocks to obtain the upper left, upper right, lower-left, and lower-right motion vectors.

10. The method of claim 8, wherein when all of the differences Diff(u), Diff(d), Diff(l), and Diff(r) are less than a second reference value, step (b2) comprises determining motion vectors of the sub-blocks contained in the current macroblock as an average of the upper left, upper right, lower-left, and lower-right motion vectors.

11. The method of claim 8, wherein when both of the differences Diff(u) and Diff(d) are less than a second reference value and when at least one of the differences Diff(l) and Diff(r) is equal to or greater than the second reference value, step (b2) comprises determining motion vectors of sub-blocks contained in the upper left and upper right blocks as an average of the upper left motion vector and the upper right motion vector and determining motion vectors of sub-blocks contained in the lower-left and lower-right blocks as an average of the lower-left motion vector and the lower-right motion vector.

12. The method of claim 8, wherein when both of the differences Diff(l) and Diff(r) are less than a second reference value and when at least one of the differences Diff(u) and Diff(d) is equal to or greater than the second reference value, step (b2) comprises determining motion vectors of sub-blocks contained in the upper left and lower-left blocks as an average of the upper left motion vector and the lower-left motion vector and determining motion vectors of sub-blocks contained in the upper right and lower-right blocks as an average of the upper right motion vector and the lower-right motion vector.

13. The method of claim 10, wherein the first reference value comprises a one pixel size and the second reference value comprises a half pixel size.

14. The method of claim 11, wherein the first reference value comprises a one pixel size and the second reference value comprises a half pixel size.

15. The method of claim 12, wherein the first reference value comprises a one pixel size and the second reference value comprises a half pixel size.

16. The method of claim 10, wherein the motion estimation is performed based on a variable block having a variable size and a variable shape, and the variable size and the variable shape of the variable block are determined in such a range that the motion vectors of the sub-blocks obtained using the motion vectors of the representative sub-blocks are the same.

17. The method of claim 11, wherein the motion estimation is performed based on a variable block having a variable size and a variable shape, and the variable size and the variable shape of the variable block are determined in such a range that the motion vectors of the sub-blocks obtained using the motion vectors of the representative sub-blocks are the same.

18. The method of claim 12, wherein the motion estimation is performed based on a variable block having a variable size and a variable shape, and the variable size and the variable shape of the variable block are determined in such a range that the motion vectors of the sub-blocks obtained using the motion vectors of the representative sub-blocks are the same.

19. A method of encoding a moving picture using motion compensation prediction based on a variable block, the method comprising determining a size and a shape of a unit block, on which motion estimation is performed, by using a relationship among motion vectors of representative sub-blocks of macroblocks each containing a plurality of sub-blocks.

20. The method of claim 19, wherein determining the size and the shape of the unit block comprises:
(a) obtaining the motion vectors of the representative sub-blocks of macroblocks each containing a plurality of sub-blocks, respectively; and
(b) determining the size and the shape of the unit block, on which motion estimation is performed, according to the relationship among the motion vectors of the representative sub-blocks.

21. The method of claim 20, wherein step (a) comprises searching a predetermined search range defined based on a motion vector predicted from motion vectors of representative sub-blocks of respective macroblocks adjacent to a current macroblock, thereby obtaining a motion vector of a current macroblock.

22. The method of claim 20, wherein each macroblock has a size of 16×16 pixels; each of the sub-blocks contained in each macroblock has a size of 4×4 pixels; and a representative sub-block of each macroblock is one sub-block among sub-blocks located at a center of the macroblock.

23. The method of claim 20, wherein when a difference between a motion vector of a representative sub-block of a current macroblock and each of motion vectors of representative sub-blocks of adjacent macroblocks is less than a first reference value, step (b) comprises determining motion vectors of respective sub-blocks contained in the current macroblock as the motion vector of the representative sub-block of the current macroblock.

24. The method of claim 23, wherein the adjacent macroblocks are located above, below, on the left of, and on the right of the current macroblock.

25. The method of claim 23, wherein the first reference value comprises a one pixel size.

26. The method of claim 20, wherein when a difference between a motion vector of a representative sub-block of a current macroblock and a motion vector of at least one representative sub-block among representative sub-blocks of adjacent macroblocks is equal to or greater than a first reference value, step (b) comprises:
(b1) dividing the current macroblock into four blocks comprising upper left, upper right, lower-left, and lower-right blocks and obtaining upper left, upper right, lower-left, and lower-right motion vectors of representative sub-blocks of the divided four blocks; and
(b2) determining the size and the shape of the unit block for motion estimation using a difference Diff(u) between the upper left motion vector and the upper right motion vector, a difference Diff(d) between the lower-left motion vector and the lower-right motion vector, a difference Diff(l) between the upper left motion vector and the lower-left motion vector, and a difference Diff(r) between the upper right motion vector and the lower-right motion vector.

27. The method of claim 26, wherein step (b1) comprises performing a search in a range determined using the motion vectors of the representative sub-blocks of the adjacent macroblocks to obtain the upper left, upper right, lower-left, and lower-right motion vectors.

28. The method of claim 26, wherein when all of the differences Diff(u), Diff(d), Diff(l), and Diff(r) are less than a second reference value, step (b2) comprises determining the size and the shape of the unit block for motion estimation as a size and a shape of a macroblock.

29. The method of claim 26, wherein when both of the differences Diff(u) and Diff(d) are less than a second reference value and when at least one of the differences Diff(l) and Diff(r) is equal to or greater than the second reference value, step (b2) comprises determining the size and the shape of the unit block for motion estimation as a size and a shape of either of a block obtained by adding the upper left block and the upper right block and a block obtained by adding the lower-left block and the lower-right block.

30. The method of claim 26, wherein when both of the differences Diff(l) and Diff(r) are less than a second reference value and when at least one of the differences Diff(u) and Diff(d) is equal to or greater than the second reference value, step (b2) comprises determining the size and the shape of the unit block for motion estimation as a size and a shape of either of a block obtained by adding the upper left block and the lower-left block and a block obtained by adding the upper right block and the lower-right block.

31. The method of claim 28, wherein the first reference value comprises a one pixel size and the second reference value comprises a half pixel size.

32. The method of claim 29, wherein the first reference value comprises a one pixel size and the second reference value comprises a half pixel size.

33. The method of claim 30, wherein the first reference value comprises a one pixel size and the second reference value comprises a half pixel size.

34. The method of claim 26, wherein when at least one of the differences Diff(l) and Diff(r) is equal to or greater than a second reference value and when at least one of the differences Diff(u) and Diff(d) is equal to or greater than the second reference value, step (b2) comprises:
(b21) dividing each of the four blocks into four blocks comprising upper left, upper right, lower-left, and lower-right sub-blocks and obtaining first, second, third, and fourth motion vectors of the respective four sub-blocks of each block; and
(b22) determining the size and the shape of the unit block for motion estimation using a difference Diff(uu) between the first motion vector and the second motion vector, a difference Diff(dd) between the third motion vector and the fourth motion vector, a difference Diff(ll) between the first motion vector and the third motion vector, and a difference Diff(rr) between the second motion vector and the fourth motion vector.

35. The method of claim 34, wherein step (b2) comprises determining the size and the shape of the unit block for motion estimation as a size and a shape of any one of the four blocks when all of the differences Diff(uu), Diff(dd), Diff(ll), and Diff(rr) are less than a third reference value, as a size and a shape of either of a block obtained by adding the upper left sub-block and the upper right sub-block and a block obtained by adding the lower-left sub-block and the lower-right sub-block when both of the differences Diff(uu) and Diff(dd) are less than the third reference value and at least one of the differences Diff(ll) and Diff(rr) is equal to or greater than the third reference value, and as a size and a shape of either of a block obtained by adding the upper left sub-block and the lower-left sub-block and a block obtained by adding the upper-right sub-block and the lower-right sub-block when both of the differences Diff(ll) and Diff(rr) are less than the third reference value and at least one of the differences Diff(uu) and Diff(dd) is equal to or greater than the third reference value.

36. The method of claim 35, wherein the first reference value comprises a one pixel size, the second reference value comprises a half pixel size, and the third reference value comprises a ¼ pixel size.

37. An apparatus for encoding a moving picture using motion compensation prediction, the apparatus comprising a motion estimation unit which estimates a motion of an input image using the input image and a reference frame so that the estimated motion is used for motion compensation temporal filtering,
wherein the motion estimation unit obtains motion vectors of representative sub-blocks of macroblocks each containing a plurality of sub-blocks, respectively, and estimates a motion of the input image using relationships among the motion vectors of the representative sub-blocks.

38. The apparatus of claim 37, wherein the motion estimation unit comprises:
a sub-block motion estimator which obtains the motion vectors of the representative sub-blocks;
a mode determiner which selects a unit block for the motion estimation using the relationships among the motion vectors obtained by the sub-block motion estimator;
a search range determination and motion vector prediction part which transmits a search range and a prediction value for a motion vector of each of predetermined sub-blocks to the sub-block motion estimator when a mode is not determined by the mode determiner.

39. The apparatus of claim 40, wherein the search range determination and motion vector prediction part obtains the prediction value for the motion vector using adjacent motion vectors.

40. The apparatus of claim 41, wherein the search range determination and motion vector prediction part determines the search range for the motion vector as a range of motion vectors of representative sub-blocks of macroblocks respectively located above, below, on the left of, and on the right of a macroblock to which a predetermined sub-block belongs.
